(19) United States
(12) Patent Application Publication
(10) Pub. No.: US 2006/0028920 A1
(43) Pub. Date: Feb. 9, 2006

(54) Solar battery timepiece dial plate and timepiece

(75) Inventors: Kazuyuki Kojima, Chino-shi (JP); Nobuhiko Nakanishi, Shiojiri-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/175,225

(22) Filed: Jul. 7, 2005

(30) Foreign Application Priority Data
Jul. 7, 2004 (JP) JP2004-200398

(51) Int. Cl. G04C 3/00; G04B 1/00

(52) U.S. Cl. 368/205

(57) ABSTRACT

The object of the present invention is to provide a solar timepiece dial having excellent light transmittance and ornamental qualities (aesthetic appearance) and to provide a timepiece that can supply a sufficient amount of external light to a solar battery and has excellent ornamental qualities. The solar timepiece dial is configured to be used in a solar timepiece provided with a solar battery and includes a substrate made of a material having a light transmissive quality, a light polarizer provided on the surface of the substrate that faces toward the solar battery and functioning to polarize incident light, and a diffusion layer that is arranged between the substrate 11 and the light polarizer 13 and made of a material containing a diffusion agent functioning to diffuse incident light. The light polarizer is configured to transmit a first light having a prescribed vibrational direction and reflect a second light having a vibrational direction that is perpendicular to the vibrational direction of the first light.

### TECHNICAL FIELD

The present invention relates to a dial for a solar timepiece and to a timepiece.

### BACKGROUND ART

Timepiece (watch) dials are required both to function as practical components and to posses the ornamental qualities (aesthetic appearance) of ornamental components. In solar timepieces equipped with a solar battery in which the solar battery (solar cell) is arranged under the dial (solar timepiece dial), the dial needs to have excellent light transmittance and also possess the ornamental qualities (aesthetic appearance) of an ornamental component.

More specifically, a solar timepiece dial must allow an amount of light sufficient to drive the timepiece to pass through to the solar battery arranged there-below while, simultaneously, possessing the ornamental qualities of an ornamental component.

In order to ensure that a sufficient amount of light strikes the solar battery, some conventional solar timepieces use the solar battery itself as the dial and other conventional timepieces use a dial that is formed such that no colored parts (particularly darkly colored members) are arranged over the solar battery and has a color similar to that of the solar battery (normally black or purple).

However, in recent years, there is a strong demand for dials of various colors to be used in solar timepieces depending on the specifications of the timepiece. More particularly, there is a strong demand for bright colored and light colored (e.g., white) solar timepiece dials that also possess an excellent external appearance (high-quality appearance).

Solar timepiece dials employing ceramic as their main constituent material have been used in an attempt to prevent the solar battery from being visible through the dial (e.g., Patent Document 1), but such dials are expensive and are problematic in terms of strength because they break easily when dropped or otherwise subjected to physical shock.

[Patent Document 1] Japanese Laid-open Patent Publication No. 10-39048 (claims and paragraph 0060)

### DISCLOSURE OF THE INVENTION

The object of the present invention is to provide a solar timepiece dial having excellent light transmittance and ornamental qualities (aesthetic appearance) and to provide a timepiece that can supply a sufficient amount of external light to a solar battery and has excellent ornamental qualities.

In order to achieve the object described above, the present invention offers a solar timepiece dial used in a solar timepiece equipped with a solar battery, the solar timepiece dial comprising:
a substrate made of a material having light transmittance;
a light polarizer provided on the surface of the substrate that faces toward the solar battery and functioning to polarize incident light;
a diffusion layer that is arranged between the substrate and the light polarizer and made of a material containing a diffusion agent functioning to diffuse incident light.

As a result, a solar timepiece dial having excellent light transmittance and excellent ornamental qualities (aesthetic appearance) can be provided.

In a solar timepiece dial in accordance with the present invention, it is preferred for the light polarizer to be a reflective light polarizer configured to transmit a first light having a prescribed vibrational direction and reflect a second light having a vibrational direction that is perpendicular to the vibrational direction of the first light.

By employing such a light polarizer, the solar timepiece dial can effectively prevent the base color of the solar battery from being visible there-through while also possessing sufficiently high light transmittance and the solar timepiece dial has particularly excellent ornamental qualities (aesthetic appearance).

In a solar timepiece dial in accordance with the present invention, the light polarizer is preferably a film comprising a plurality of layers laminated on top of one another.

By employing such a light polarizer, the solar timepiece dial can more effectively prevent the base color of the solar battery from being visible there-through while also possessing sufficiently high light transmittance and can be imparted with particularly excellent ornamental qualities (aesthetic appearance).

In a solar timepiece dial in accordance with the present invention, the light polarizer is preferably a film comprising alternating layers made chiefly of polyethylene naphthalate and chiefly of a co-polyester of naphthalene dicarbonate and terephthalate.

By employing such a light polarizer, the solar timepiece dial can more effectively prevent the base color of the solar battery from being visible there-through while also possessing sufficiently high light transmittance and can be imparted with particularly excellent ornamental qualities (aesthetic appearance).

In a solar timepiece dial in accordance with the present invention, the light polarizer is preferably made chiefly of a polyester resin.

By making the light polarizer out of a polyester resin, the overall light transmittance of the solar timepiece dial decreases and the base color of the solar battery can be prevented even more effectively from being visible through the dial. Also, when a white substrate is used, the whiteness of the solar timepiece dial as a whole can be improved.

In a solar timepiece dial in accordance with the present invention, the diffusion layer is preferably made of a material having an adhesive or bonding quality.

By making the diffusion layer out of such a material, the adhesion between the substrate and the light polarizer can be improved and, thus, the shock resistance of the solar timepiece dial can be improved, enabling the solar timepiece dial to function exceptionally reliably as both a practical component and an ornamental component.

In a solar timepiece dial in accordance with the present invention, the diffusion layer is preferably made chiefly of an acrylic adhesive.

By making the diffusion layer chiefly out of an acrylic adhesive, particularly excellent adhesion can be achieved between the substrate and the light polarizer while sufficiently maintaining the overall light transmittance and aesthetic appearance of the solar timepiece dial.

In a solar timepiece dial in accordance with the present invention, the substrate is preferably made chiefly of polycarbonate and/or an acrylonitrile-butadiene-styrene copolymer.

By making the substrate out of such a material, for example, particularly excellent adhesion can be obtained between the substrate and the diffusion layer. Additionally, a solar timepiece dial having particularly excellent strength can be obtained and the degree of freedom with respect to forming (molding) the solar timepiece dial (substrate) during manufacturing can be increased (i.e., the dial is easier to form). Furthermore, a printed layer can be formed as appropriate on the surface of the substrate.

In a solar timepiece dial in accordance with the present invention, it is preferable for the light transmittance of visible light traveling from the side where the substrate is provided to the side where the light polarizer is provided to be 20% or higher.

When said light transmittance, light incident on the solar timepiece dial can be passed more efficiently to the solar battery while sufficiently maintaining the excellent ornamental quality (aesthetic appearance) of the solar timepiece dial (and of the entire timepiece in which the solar timepiece dial is installed).

A solar timepiece dial in accordance with the present invention preferably possesses a white external appearance.

When the external appearance is white, a solar timepiece dial 1 that exudes particularly superb ornamental qualities (especially a feeling of high quality) can be obtained.

A solar timepiece dial in accordance with the present invention is preferably a dial for a wristwatch.

Wristwatches are typically not used under fixed environmental circumstances and thus wristwatches need to possess excellent ornamental and practical qualities suitable for a variety of environments. Furthermore, the wristwatch dial used in a solar wristwatch (solar wristwatch dial) needs to have particularly excellent ornamental qualities and light transmittance in comparison with other solar timepiece dials. Therefore, although the present invention is applicable to various timepiece dials (solar timepiece dials), it is particularly well suited for wristwatch dials.

The present invention relates to a timepiece, having: a solar battery;
a substrate made of a material having light transmittance;
a light polarizer provided on the surface of the substrate that faces toward the solar battery and functioning to polarize incident light;
a diffusion layer that is arranged between the substrate and the light polarizer and made of a material containing a diffusion agent functioning to diffuse incident light.

As a result, a sufficient amount of external light can be supplied to the solar battery and a timepiece (solar timepiece) having excellent ornamental qualities can be provided.

A timepiece in accordance with the present invention is also provided with a solar timepiece dial in accordance with the present invention.

As a result, a sufficient amount of external light can be supplied to the solar battery and a timepiece (solar timepiece) having excellent ornamental qualities can be provided.

### BRIEF DESCRIPTIONS OF THE DRAWINGS

FIG. 1 is a cross sectional view showing a preferred embodiment of a solar timepiece dial in accordance with the present invention.

FIG. 2 is a schematic view showing a preferred embodiment of a light polarizer that comprises a plurality of laminated layers and can be used in the present invention.

FIG. 3 is a cross sectional view showing a preferred embodiment of a wristwatch (portable timepiece) in accordance with the present invention.

FIG. 4 is a perspective view showing a preferred embodiment of a wristwatch (portable timepiece) in accordance with the present invention.

### PREFERRED EMBODIMENTS OF THE INVENTION

Preferred embodiments of the present invention will now be described with reference to the drawings. It will be apparent to those skilled in the art from this disclosure that the following descriptions of the embodiment of the present invention are provided for illustration only and not for the purpose of limiting the invention as defined by the appended claims and their equivalents. First, a preferred embodiment of a solar timepiece dial in accordance with the present invention will be described.

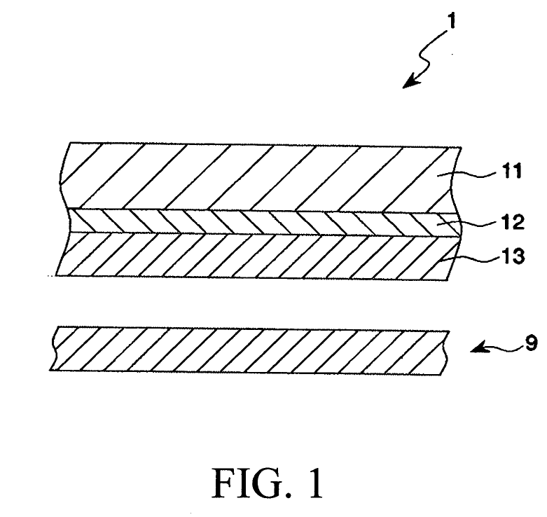

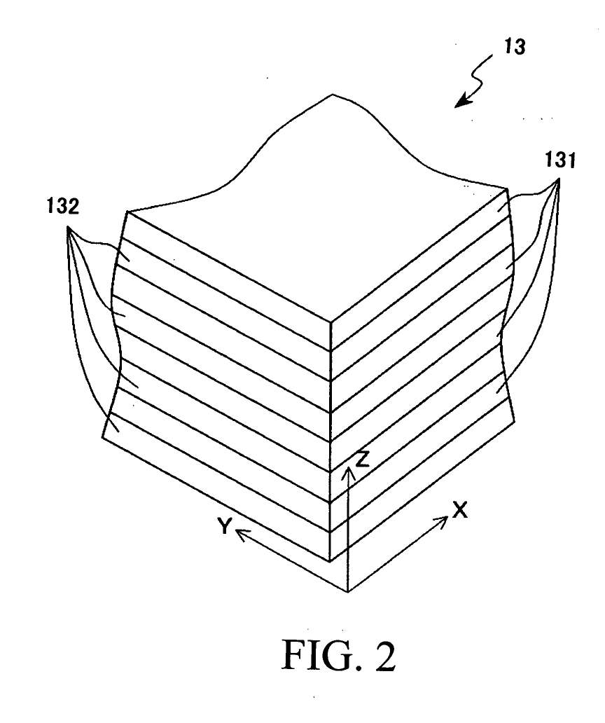

FIG. 1 is a cross sectional view of a preferred embodiment of a solar timepiece dial in accordance with the present invention and FIG. 2 is a schematic view of a preferred embodiment of a light polarizer that comprises a plurality of laminated layers.

The solar timepiece dial 1 is configured to be used in a solar timepiece equipped with a solar battery 9.

As shown in FIG. 1, the solar timepiece dial 1 of this embodiment has a substrate 11, a light polarizer 13 provided on the side of the substrate 11 that faces the solar battery 9, and a diffusion layer (diffuser) 12 arranged between the substrate 11 and the light polarizer 13.

Thus, since it has a diffusion layer and a light polarizer, a solar timepiece dial in accordance with the present invention can effectively prevent the base color of the solar battery from being visible there-through while also possessing sufficiently high light transmittance. The solar timepiece dial also has particularly excellent ornamental qualities (aesthetic appearance).

The substrate 11, the diffusion layer 12, and the light polarizer 13 will now be described in detail.

[Substrate]

The substrate 11 is made of a material having a light transmissive quality.

The substrate 11 can be made of, for example, any of various plastic, glass, and ceramic materials but it is preferred that the substrate 11 be made of plastic (particularly heat resistant plastic). By using plastic, a solar timepiece dial 1 that is, for example, comparatively lightweight and easy to carry can generally be provided. Also, by using plastic, the solar timepiece dial can be formed into the desired shape comparatively easily. Additionally, by using a non metal material, a dial that is also well suited for a radio controlled timepiece can be obtained.

Plastic materials from which the substrate 11 can be made include any of various thermoplastic resins and thermosetting resins. For example, the substrate can be made of any one of the following materials, a copolymer, blend, or polymer alloy made chiefly of one of the following materials, or a combination of two or more of the following materials (e.g., a blend resin, polymer alloy, or laminate made with two or more of the following materials): polyolefins such as polyethylenes, polypropylenes, ethylene-propylene copolymers, and ethylene-vinyl acetate copolymers (EVA); cyclic polyolefins; modified polyolefins; polyvinyl chlorides; polyvinylidene chlorides; polystyrenes; polyamides (e.g., nylon 6, nylon 46, nylon 66, nylon 610, nylon 612, nylon 11, nylon 12, nylon 6-12, nylon 6-66); polyimides; polyamide-imides; polycarbonates (PC); poly-(4-methylpentene-1), ionomers; acrylic resins; polymethyl methacrylates; acrylonitrile-butadiene-styrene copolymers (ABS resins); acrylonitrile-styrene copolymers (AS resins); butadiene-styrene copolymers; polyoxymethylenes; polyvinyl alcohols (PVA); ethylene-vinyl alcohol copolymer (EVOH); polyesters such as polyethylene terephthalates (PET), polybutylene terephthalates (PBT), and polycyclohexane terephthalates (PCT); polyethers; polyether ketones (PEK); polyether ether ketones (PEEK); polyether imides; polyacetals (POM); polyphenylene oxides; modified polyphenylene oxides; polysulfones; polyethersulfones, polyphenylene sulfides; polyarylates; aromatic polyesters (liquid crystal polymers); polytetrafluoroethylenes, polyvinylidene fluorides, and other fluororesins; various thermoplastic elastomers based on a styrene, polyolefin, polyvinyl chloride, polyurethane, polyester, polyamide, polybutadiene, trans polyisoprene, fluororubber, or polyethylene chloride; epoxy resins, phenolic resins; urea resins; melamine resins; unsaturated polyesters; silicone resins; urethane resins; and poly-paraxylylene resins such as polyparaxylylene, poly-monochloro-paraxylylene, poly-dichloro-paraxylylene, poly-monofluoro-paraxylylene, and poly-monoethyl-paraxylylene. More particularly, the substrate 11 is preferably made chiefly of polycarbonate and/or an acrylonitrile-butadiene-styrene copolymer. By using such a material, for example, particularly excellent adhesion can be obtained between the substrate 11 and the diffusion layer 12 (described later). Additionally, the solar timepiece dial 1 can be made to have particularly excellent strength and the degree of freedom with respect to forming (molding) the solar timepiece dial 1 (substrate 11) during manufacturing can be increased (i.e., the dial 1 is easier to form). Furthermore, a printed layer can be formed as appropriate on the surface of the substrate 11.

The substrate 11 can be configured such that the composition thereof is substantially uniform at all positions (portions) thereof or such that the composition thereof differs depending on the position. For example, the substrate 11 can have a base part and a coloring layer or other coating layer provided on the base part. In such a case, the coating layer can be made using any of various paint application methods, printing methods, wet plating methods, and dry plating methods.

There are no particular limitations on the shape and size of the substrate 11 and these are normally determined based on the shape and size of the solar timepiece dial 1. Although the substrate 11 (solar timepiece dial 1) shown in the figures is shaped like a flat disc, it is also acceptable for the substrate 11 to have the shape of a curved plate.

There are no particular limitations regarding the color of the substrate 11 so long as the substrate 11 is light transmissive (i.e., permeable with respect to the wavelengths of light that can be used to drive the solar battery 9 and store electricity). When the substrate 11 is white, the solar timepiece dial 1 can exude a particularly superb aesthetic appearance (especially when installed in a watch 100) and the solar timepiece dial 1 and timepiece 100 can be made to appear to be of even higher quality. When the substrate 11 is substantially transparent (more specifically, when the light transmittance with respect to visible light is 90% or higher), the solar timepiece dial 1 can be imparted with a high light transmittance and the size the solar battery 9 can be reduced.

Although there are no particular limitations on the thickness of the substrate 11, a thickness of 200 to 700 μm is preferable and a thickness of 300 to 600 μm is even more preferable. By setting the average thickness of the substrate 11 to a value in the aforementioned range, the solar timepiece dial 1 can more effectively prevent the base color of the solar battery 9 from being visible there-through while also possessing sufficiently high light transmittance and, thus, can be imparted with particularly excellent ornamental qualities (aesthetic appearance).

Although not shown in FIG. 1, time indicating graduations (tick marks), decorative lettering, and other markings are provided on the external surface of the substrate 11 (the side (surface) of the substrate 11 that is opposite the side facing the solar battery 9).

[Diffusion Layer]

The diffusion layer 12 is made of a material containing a diffusion agent that functions to diffuse incident light. Thus, while light (external light) striking the diffusion layer 12 from the substrate 11 side is allowed to pass through to the light polarizer 13 (described later), a portion of the incident light can be diffused back toward the substrate 11. Similarly, light that strikes the diffusion layer 12 from the light polarizer 13 (described later) side can be passed out while being diffused toward the substrate 11. As a result, the light (external light) striking the diffusion layer 12 from the substrate 11 side can be passed through to the light polarizer 13 (solar battery 9) while also effectively preventing the solar battery 9 from being visible through the solar timepiece dial 1. In other words, the solar timepiece dial 1 can be imparted with a superb aesthetic appearance (particularly when installed in a timepiece 100) and still allow the light required to drive the solar battery 9 and store electricity to reach the solar battery 9. In particular, since the diffusion layer 12 causes light to be passed (diffused) toward the substrate 11, the appearance of the solar timepiece dial 1 has a higher degree of whiteness and the solar timepiece dial 1 appears to be of higher quality.

The diffusion agent used in the diffusion layer 12 can be anything so long as it functions to diffuse light.

The diffusion agent can also have any shape or form, e.g., particulate (powder), flakes, needle-shaped, etc., or it can have an irregular form. It is also acceptable for the diffusion layer 12 to be made substantially of the diffusion agent alone.

Examples of the material from which the diffusion agent can be made include silica, glass, and resin.

The diffusion layer 12 is preferably made of a material having an adhesive or bonding quality. By using such a material, the adhesion between the substrate 11 and the light polarizer 13 can be improved and, thus, the shock resistance of the solar timepiece dial 1 can be improved, enabling the solar timepiece dial to function exceptionally reliably as both a practical component and an ornamental component.

Examples of materials having an adhesive or bonding quality (adhesive/bonding material) include any material that is used as an adhesive or bonding agent, bit it is preferable to use an acrylic resin as the adhesive/bonding agent. By using an acrylic resin material, particularly excellent adhesion can be achieved between the substrate 11 and the light polarizer 13 while sufficiently maintaining the overall light transmittance and aesthetic appearance of the solar timepiece dial 1.

When the diffusion layer 12 includes an adhesive/bonding material like that just described, it is preferable for the diffusion layer 12 to be made chiefly of the adhesive/bonding material. By making the diffusion layer 12 chiefly of the adhesive/bonding material, the aforementioned effects can be exhibited more demonstrably.

[Light Polarizer]

The light polarizer 13 functions to polarize light that is incident thereon.

The inventor has discovered that by arranging the light polarizer 13 closer to the solar battery 9 than the substrate 11 (i.e., by configuring the dial 1 such that the constituent parts thereof are arranged in the following order from closest to farthest relative to the solar battery 9: light polarizer 13, diffusion layer 12, substrate 11), the solar timepiece dial 1 can effectively prevent the base color of the solar battery 9 from being visible there-through while also possessing sufficiently high light transmittance and the solar timepiece dial 1 can be imparted with particularly excellent ornamental qualities (aesthetic appearance).

Although it is acceptable for the light polarizer 13 to be anything that functions to polarize incident light, it is preferred for the light polarizer 13 to be a reflective light polarizer configured to transmit a first light having a prescribed vibrational direction and reflect a second light having a vibrational direction that is perpendicular to the vibrational direction of the first light. By configuring the light polarizer 13 in said preferred manner, the solar timepiece dial 1 can prevent the base color of the solar battery 9 from being visible there-through while also possessing sufficiently high light transmittance and can be imparted with particularly excellent ornamental qualities (aesthetic appearance).

The light polarizer (reflective polarizer) 13 can be made of material. For example, it can be made chiefly of a polyester resin. By using a polyester resin, the overall light transmittance of the solar timepiece dial 1 decreases and the base color of the solar battery can be prevented even more effectively from being visible through the dial 1. Also, when a white substrate 11 is used, the whiteness of the solar timepiece dial 1 as a whole can be improved.

Also, the light polarizer (reflective polarizer) 13 is preferably a film (laminate) comprising a plurality of layers laminated on top of one another. By configuring the light polarizer 13 as a film, the solar timepiece dial 1 can prevent the base color of the solar battery 9 from being visible there-through while also possessing sufficiently high light transmittance and can be imparted with particularly excellent ornamental qualities (aesthetic appearance).

FIG. 2 shows a preferred embodiment of a light polarizer 13 made up of a plurality of laminated layers.

As shown in FIG. 2, the laminate light polarizer 13 is made of two types of layers, i.e., a polarizing film layer (first layer) 131 and a polarizing film layer (second layer) 132, that are stacked on top of one another in an alternating fashion. In this light polarizer 13, the refractive index (n_{AX}) in the X-axis direction of the first layer 131 is different from the refractive index (n_{BX}) in the X-axis direction of the second layer 132 but the refractive index (n_{AY}) in the Y direction of the first layer 131 and the refractive index (n_{BY}) in the Y direction of the second layer 132 are substantially equal. Since the refractive index in the Y direction is substantially the same for both the first layer 131 and the second layer 132, the portion of light incident on the light polarizer 13 that is linearly polarized in the Y direction passes through the light polarizer 13. Meanwhile, assuming the average thickness of a first layer 131 in the Z direction is tA and the average thickness of a second layer 132 is tB, when light having wavelength λ is incident on the light polarizer 13, the portion of the incident light that is linearly polarized in the X direction will be substantially reflected by the polarizer 13 as dictated by the equation (I) below.
t_{A}×n_{AX}+t_{B}×n_{BX}=λ/2 (1)

Since the average thicknesses of the first layers 131 in the Z direction and the average thicknesses of the second layers 132 in the Z direction are varied, the light polarizer 13 reflects a wide range of visible wavelengths of incident light that is linear polarized in the X direction.

With such a light polarizer 13, a portion of the light incident on the dial 1 can pass through the dial 1 and be used to store energy in the solar battery 9 and a portion of the incident light can be reflected so as to efficiently prevent the base color of the solar battery 9 arranged under the substrate 11 from being visible through the dial 1.

When the light polarizer 13 is made of laminate as describe above, each layer (first layer 131 and second layer 132) can be made of any material. However, it is preferable for the first layer 131 of the light polarizer 13 to be made of polyethylene naphthalate (more particularly, a drawn film made of polyethylene naphthalate) and the second layer 132 to be made of a co-polyester comprising naphthalene carbonate and terephthalate. By making the layers of the light polarizer 13 out of such materials, the solar timepiece dial 1 can prevent the base color of the solar battery 9 from being visible there-through while also possessing sufficiently high light transmittance and can be imparted with particularly excellent ornamental qualities (aesthetic appearance). Additionally, the materials used to make the light polarizer 13 are not limited to those mentioned above. Any material that is known to be well suited for forming a polarizing film (polarizing plate) in this technical field can be selected and used as appropriate depending on the particular design considerations.

There are no particular limitations on the number of layers provided when the light polarizer 13 is a laminate like that described above, but is preferable for 2 to 20 layers to be provided, more preferable for 6 to 12 layers to be provided, and still more preferable for 8 to 10 layers to be provided. By providing the preferred number of layers, the aforementioned effects can be exhibited more demonstrably.

Although there are no particular limitations on the thickness of the polarizer 13, a thickness of 20 to 300 μm is preferable and a thickness of 100 to 200 μm is even more preferable. By setting the average thickness of the light polarizer 13 to a value in the aforementioned range, the solar timepiece dial 1 can more effectively prevent the base color of the solar battery 9 from being visible there-through while also possessing sufficiently high light transmittance and, thus, can be imparted with particularly excellent ornamental qualities (aesthetic appearance).

[Solar Timepiece Dial]

A solar timepiece dial 1 is arranged on a timepiece (solar timepiece) in a position above the solar battery 9 (on the side of the solar battery 9 configured to receive light).

It is preferable for the light transmittance of the solar timepiece dial 1 to be 20% or higher with respect to visible light traveling from the substrate 11 side toward the light polarizer 13 side. It is more preferable for the same light transmittance to be in the range of 21% to 80% and still more preferable for the same light transmittance to be in the range of 22% to 70%. When the light transmittance is in such a range, light incident on the solar timepiece dial 1 can be passed more efficiently to the solar battery 9 while sufficiently maintaining the excellent ornamental qualities (aesthetic appearance) of the solar timepiece dial 1 (and of the entire timepiece in which the solar timepiece dial 1 is installed). Conversely, if the light transmittance is too low, it will sometimes be difficult for an amount of light sufficient to drive the solar battery 9 and store electricity to reach the solar battery. Meanwhile, if the light transmittance is too high, it might be difficult to achieve sufficiently excellent ornamental qualities (a sufficient aesthetic appearance) for the solar timepiece dial 1 (and for the entire timepiece in which the solar timepiece dial 1 is installed).

The solar timepiece dial 1 can be any color but it is preferable for it to have a white appearance. When it is white, the solar timepiece dial 1 can exude particularly superb ornamental qualities (especially a feeling of high quality).

An example of a method of manufacturing the solar timepiece dial 1 described above will now be described.

First, the diffusion layer 12 is formed on the back surface (non-printed surface) of the substrate 11 using a paint application method or other method. The substrate 11 and the diffusion layer 12 can be made of any of the respective materials described previously. Next, the light polarizer 13 is attached to the surface of the diffusion layer 12 formed on the substrate 11. If the diffusion layer 12 is made of an adhesive/bonding material like that described previously, the attachment of the light polarizer 13 to the substrate 11 can be accomplished more efficiently. The light polarizer 13 can be a light polarizer like that described previously. By heating a structure comprising a substrate 11, diffusion layer 12, and light polarizer 13 as just described (more specifically, by curing the material constituting the diffusion layer 12), a stronger adhesion can be obtained between the light polarizer 13 and the substrate 11.

The solar timepiece dial described heretofore can be used in any solar timepiece but it is preferably used in a wristwatch (as a wristwatch dial). The environment in which a wristwatch is used is typically not fixed and the wristwatch needs to possess excellent ornamental and practical qualities suitable for a variety of environments. Furthermore, the wristwatch dial used in a solar wristwatch (solar wristwatch dial) needs to have particularly excellent ornamental qualities and light transmittance in comparison with other solar timepiece dials. Therefore, although the present invention is applicable to various timepiece dials (solar timepiece dials), it is particularly well suited for wristwatch dials.

A timepiece in accordance with the present invention that is provided with a solar timepiece dial in accordance with the present invention will now be described.

A timepiece in accordance with the present invention has a solar timepiece dial in accordance with the present invention, i.e., a solar timepiece dial like that described previously. As described previously, a solar timepiece dial in accordance with the present invention has excellent light transmittance and superb ornamental qualities (a superb aesthetic appearance). Consequently, since it is provided with such a solar timepiece dial, a timepiece in accordance with the present invention can easily satisfy the requirements of a solar timepiece. Except for the timepiece components described previously, any commonly known parts can be used as the component parts of a timepiece in accordance with the present invention. However, an example of the component parts of a timepiece in accordance with the present invention will now be described.

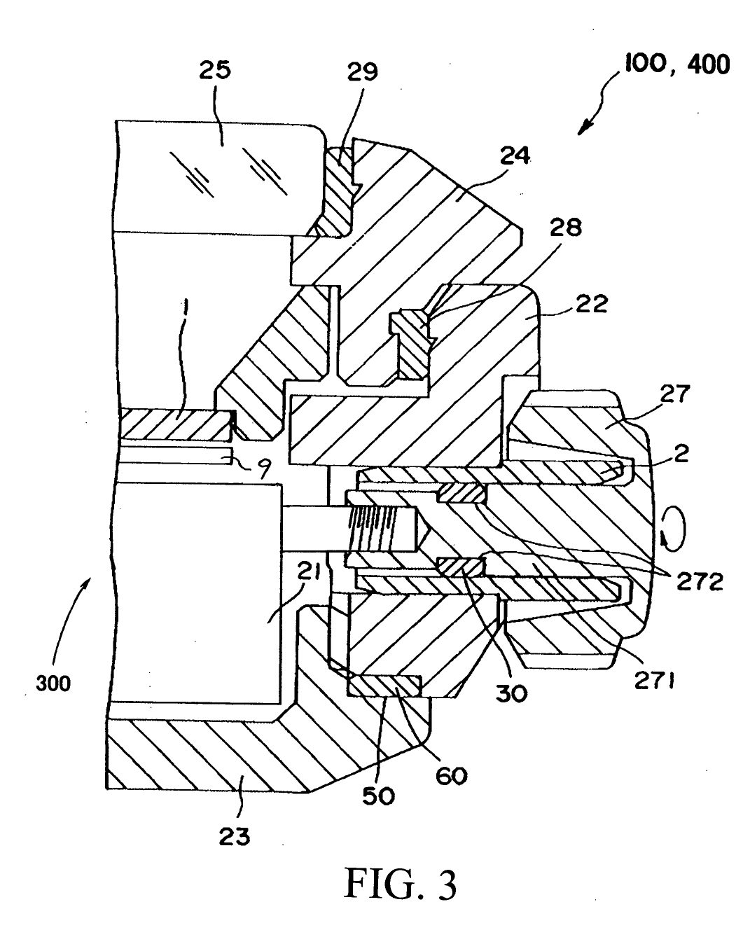

FIG. 3 is a cross sectional view showing a preferred embodiment of a wristwatch (portable timepiece) in accordance with the present invention.

As shown in FIG. 3, the wristwatch (portable timepiece) 100 of this embodiment has a body (case) 22, a back cover 23, a bezel 24, and a crystal (glass cover) 25. A solar timepiece dial 1 like that described previously, a solar battery 9, and a drive unit 300 that includes a movement 21 and serves to process time information are housed inside the case 22. Additionally, hands (time indicating needles) not shown in the figures are also housed inside the case 22.

The crystal 25 is normally made of transparent glass, sapphire, or material having a high degree of transparency. As a result, the aesthetic beauty of the solar timepiece dial 1 can be exhibited thoroughly and a sufficient amount of light can be fed to the solar battery 9.

The movement 21 uses electric power from the solar battery 9 to drive the hands.

Although omitted from FIG. 3, the movement 21 includes, for example, an electric double layer capacitor configured and arranged to store electric power from the solar battery 9, a lithium ion secondary battery, a crystal oscillator serving as a time reference, a semiconductor integrated circuit configured to generate drive pulses for driving the timepiece based on the oscillating frequency of the crystal oscillator, a stepping motor configured to receive the drive pulses and drive the hands once per second, and a wheel train mechanism for transmitting the movement of the stepping motor to the hands.

The solar battery 9 functions to convert light energy into electrical energy. The electric energy produced by the solar battery 9 is then used to drive movement.

The solar battery 9 has, for example, a PIN structure comprising a non-single-crystal silicon thin film selectively doped with a p-type impurity, a non-single-crystal silicon thin film selectively doped with an n-type impurity, and an i-type non-single-crystal silicon thin film having a low impurity concentration arranged between the p-type non-single-crystal silicon thin film and the n-type non-single-crystal silicon thin film.

A winding stem pipe 26 is press fitted and thereby fixed into the body 22, and the winding stem (shaft part) 271 of a winding crown 27 is arranged in a rotatable manner inside the winding stem pipe 26.

The bezel 24 and body 22 are fastened together by means of plastic packing 28, and the bezel 24 and crystal 25 are fastened together by means of plastic packing 29.

The back cover 23 is press fitted (or screwed) to the body 22 and the joint (seal part) 50 between the two is sealed by a ring-shaped rubber packing (back cover packing) 60 that is installed so as to be in a compressed state. This arrangement seals the seal part 50 in a watertight manner provides a waterproofing effect.

A groove 272 is formed in the outside circumference of the winding stem 271 of the winding crown 27 and a ring-shaped rubber packing (crown packing) 30 is fitted into this groove 272. The rubber packing 30 fits snugly against the internal surface of the winding stem pipe 26 and is compressed between the internal surface of the winding stem pipe 26 and the inside surface of the groove 272. This arrangement seals the gap between the crown 27 and the winding stem pipe 26 in a watertight manner and provides a waterproofing effect. When the crown 27 is wound, the rubber packing 30 turns together with the winding stem 271 and slides in a circumferential path along the internal surface of the winding stem pipe 26 while maintaining a snug fit against said internal surface.

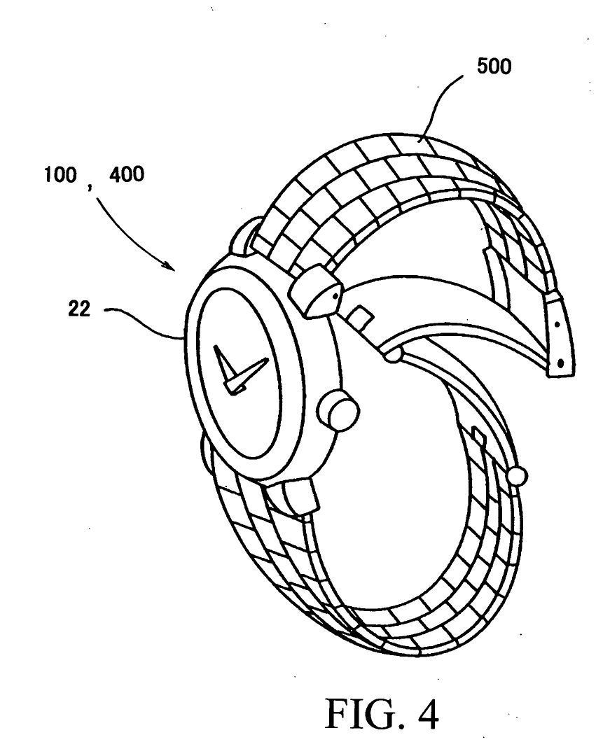

FIG. 4 is a perspective view showing a preferred embodiment of a timepiece (wristwatch) in accordance with the present invention. A band 500 is connected to the timepiece and enables the timepiece to be worn on a user's body.

Although the preceding explanation presents an example of a wristwatch (portable timepiece), the present invention can also be applied in a similar fashion to portable timepieces other than wristwatches, desk clocks (i.e., clocks designed to be placed on a flat surface), wall clocks etc.

Although the preceding explanation presents a preferred embodiment of a solar timepiece dial in accordance with the present invention and a timepiece equipped with the same, the present invention is not limited to the solar timepiece dial and timepiece described in the embodiment.

For example, in the preceding embodiment, the substrate 11 and the diffusion layer 12 contact each other and the diffusion layer 12 and the light polarizer 13 contact each other, but the invention is not limited to such a contacting arrangement. It is also acceptable, for example, for at least one intermediate layer to be provided between the substrate 11 and the diffusion layer 12 and/or between the diffusion layer 12 and the light polarizer 13.

Also, a timepiece in accordance with the present invention is within the scope of the invention so long as it has a substrate, a diffusion layer, and a light polarizer; it is not necessary for the substrate, diffusion layer, and light polarizer to be joined together. In other words, in a timepiece in accordance with the present invention, it is acceptable if the substrate, diffusion layer, and light polarizing layer do not exist as a single unified dial. For example, the substrate (dial), the diffusion layer (diffuser), and the light polarizer can exist as separate members.

### EXAMPLES

Examples of the present invention will now be described.

[Manufacture of a Solar Timepiece Dial (Wristwatch Dial)]

### Example 1

A wristwatch dial was made using a method that will now be described.

First, a substrate having the shape of a wristwatch dial was fabricated by compression molding a polycarbonate material and the required portions were cut and polished. The substrate obtained had an approximately circular disk-like shape with a diameter of 27 mm and a thickness of 0.5 mm.

After fabrication, the substrate was washed. The washing of the substrate was conducted as follows. First alkaline electrolytic degreasing was performed for 30 seconds, followed by 30 seconds of alkaline dip degreasing. Then, the neutralization was performed for 10 seconds followed by water rinsing for 10 seconds and deionized water rising for 10 seconds.

Next, a surface of the substrate was painted white and air dried and the side of the substrate opposite the side that was painted white was printed with time markings (time indicating graduations, etc.) and air dried.

Meanwhile, a light polarizer (reflective polarizer) made of a polyester resin was prepared. The light polarizer was fabricated by drawing a sheet material made of a polyester resin in one axial direction and punching the sheet material so as to obtain an generally circular disc shaped member (light polarizer) having a diameter of 27 mm. The average thickness of the light polarizer was 20 μm.

Next, a diffusion layer composite material containing a diffusion agent and an acrylic adhesive (acrylic resin) was used to attach the substrate described previously (substrate that was painted white) and the light polarizer together, thereby obtaining a solar timepiece dial comprising a substrate, a diffusion layer, and a light polarizer arranged in a laminated fashion. The substrate and the light polarizer were attached together in such a manner that the diffusion layer contacted the surface of the substrate that was painted white. Silica powder was used as the diffusion agent.

### Example 2

The wristwatch dial manufactured in this working example was the same as the dial described in Working Example 1 except that the light polarizer (reflective polarizer) was made of a film (laminate) comprising a plurality of layers laminated on top of one another (as described below).

The light polarizer used in this working example is made up of two types of layers: a layer comprising a sheet material obtained by drawing a sheet material made of polyethylene naphthalate in one axial direction and a layer comprising a sheet material obtained by drawing a sheet material made of a co-polyester of naphthalene dicarbonate and terephthalate. Said two types of layers were laminated on top of one another alternately to obtain a total of eight layers. The average thickness of the light polarizer was 160 μm.

### Comparative Example 1

A wristwatch dial was manufactured that was the same as the dial described in Working Example 1 except that an antireflective layer comprising a antireflective film was provided instead of a light polarizer.

### Comparative Example 2

A wristwatch dial was manufactured that was the same as the dial described in Working Example 1 except that a reflective layer comprising a reflective film was provided instead of a light polarizer.

### Comparative Example 3

A wristwatch dial was manufactured that was the same as the dial described in Working Example 1 except that an adhesive layer made substantially of an acrylic adhesive alone and not containing a diffusion agent was provided instead of a diffusion layer.

### Comparative Example 4

A wristwatch dial was manufactured that was the same as the dial described in Working Example 2 except that an adhesive layer made substantially of an acrylic adhesive alone and not containing a diffusion agent was provided instead of a diffusion layer.

[Evaluation]

1. Evaluation of the Light Transmittance of the Wristwatch Dial

The light transmittance of each of the solar timepiece dials obtained in the working examples and comparative examples was evaluated. The method of evaluation will now be described.

First, the dials were placed in a dark chamber with a solar battery. Then, light from a fluorescent lamp (light source) was shone directly onto the light receiving surface of the solar battery alone from a prescribed distance. The electric current (measured in milliamperes (mA)) generated by the solar battery under these conditions was called “A.” The light receiving surface of the solar battery was then covered with one of the dials and light from a fluorescent lamp (light source) was shone from a prescribed distance in the same manner as the standalone test just described. The electric current (mA) generated by the solar battery under these conditions was called “B.” The generated current was measured in the same manner for each dial. Next, the light transmittance of each dial was calculated as a percentage using the expression (B/A)×100 and ranked into one of the four reference categories shown below. The larger the light transmittance of each dial, the more light permeable the solar timepiece dial can be said to be.
(◯): 22% or higher
◯: equal to or larger than 20% but less than 22%
Δ: equal to or larger than 11% but less than 20%
x: less than 11%

Afterwards, wristwatches were manufactured using the wristwatch dials manufactured in the working examples and comparative examples described previously. The manufactured wrist watches were then placed in a dark chamber. Light from a fluorescent lamp (light source) was shone onto the time-telling surface of the dial (surface of the crystal) from a prescribed distance. The intensity of the light was gradually increased at a constant speed. As a result, it was demonstrated that the movement of a timepiece in accordance with the present invention can be driven even if the intensity of the light incident on the time-telling side of the dial is small. In contrast, the movement of the timepiece equipped with the dial of Comparative Example 2 did not operate even when the intensity of the incident light was comparatively large.

2. Evaluation of the Aesthetic Appearance of the Wristwatch Dial

Wristwatches equipped with the dials obtained in the working examples and comparative examples were observed visually and the appearance of each watch was ranked into one of the four reference categories shown below.
⊚: Superior appearance
◯: Good appearance
Δ: Somewhat flawed appearance
x: Flawed appearance

The results of the light transmittance and appearance evaluations are shown in Table 1.

TABLE 1

| | Transmittance of Dial | External Appearance |
|---|---|---|
| Experiment 1 | ⊚ | ⊚ |
| Experiment 2 | ⊚ | ⊚ |
| Comparative Exampe 1 | ⊚ | X |
| Comparative Exampe 2 | X | X |
| Comparative Exampe 3 | ⊚ | X |
| Comparative Exampe 4 | ⊚ | X |

As is clearly indicated by the results shown in Table 1, when a timepiece is provided with a solar timepiece dial in accordance with the present invention, the excellent light transmittance of the solar timepiece dial enables an amount of light sufficient to drive the solar battery and store electricity to be supplied to the solar battery and the ornamental qualities of the solar timepiece dial enable the timepiece to exude a superb aesthetic appearance.

In contrast, the solar timepiece dials of the comparative examples and the watches provided therewith did not demonstrate satisfactory results. In particular, dials of Comparative Examples 3 and 4 were not provided with diffusion layers and the aesthetic appearances thereof where demonstrably poor.

Such directional terms as “front,” “rear,” “above,” “below,” “perpendicular,” “horizontal,” and “diagonal” as used herein serve to indicate directions within the drawings used to illustrate the invention. Therefore, directional terms used herein to describe the invention should be interpreted in a relative manner within the context of the drawings.

Also, such terms of degree as “substantially”, “about” and “approximately” as used herein mean a reasonable amount of deviation of the modified term such that the end result is not significantly changed. These terms of degree can be construed as including a deviation of at least ±5% of the modified term so long as this deviation would not significantly change the end result.

All the disclosures in Japanese Patent Application No. 2004-200398 are incorporated herein by reference.

The embodiment presented herein is only one embodiment of the present invention and, based on this disclosure, it should be clear to those skilled in the art that a variety of modifications can be applied to the embodiment presented herein without exceeding the scope of the invention as defined in the claims. The embodiment presented herein is provided solely for the purpose of describing the invention and does not limit the invention as defined by the appended claims and their equivalents.

### DESCRIPTIONS OF THE REFERENCE SYMBOLS

1 timepiece dial, 9 solar battery, 11 substrate, 12 diffusion layer (diffuser), 13 light polarizer, 21 movement, 22 case, 100 timepiece, 131 first layer, 132 second layer, 300 drive unit, 400 electronic device, 500 band

1. A solar timepiece dial for covering a solar battery, the solar timepiece dial comprising:
a plate-like substrate that is arranged closely adjacent to the solar battery and possesses a light transmissive quality;
a light polarizer that is provided between the substrate and the solar battery and functions to polarize incident light;
a diffusion layer that is arranged between the substrate and the light polarizer and contains a diffusion agent functioning to diffuse incident light.

2. The solar timepiece dial recited in claim 1, wherein letters for indicating the time are provided on the substrate.

3. The solar timepiece dial recited in claim 1, wherein the light polarizer is a reflective light polarizer configured to transmit a first light that vibrates in one direction and reflect a second light that vibrates in a direction perpendicular to the vibrational direction of the first light.

4. The solar timepiece dial recited in claim 1, wherein the light polarizer is a film comprising a plurality of layers laminated on top of one another.

5. The solar timepiece recited in claim 1, wherein the light polarizer is a film comprising alternating first and second layers, the first layers being made chiefly of polyethylene naphthalate and the second layers being made chiefly of a co-polyester of naphthalene dicarbonate and terephthalate.

6. The solar timepiece dial recited in claim 5, wherein the total number of layers making up the light polarizer is equal to or more than 2 and less than or equal to 20.

7. The solar timepiece dial recited in claim 1, wherein the light polarizer is made chiefly of a polyester resin.

8. The solar timepiece dial recited in claim 1, wherein the average thickness of the light polarizer is equal to or larger than 20 μm and smaller than or equal to 300 μm.

9. The solar timepiece dial recited in claim 1, wherein
the diffusion layer has an adhesive or bonding quality and is made chiefly of an acrylic adhesive; and
the diffusion layer is made of silica, glass, or resin.

10. The solar timepiece dial recited in claim 1, wherein the substrate is made of a heat resistant plastic.

11. The solar timepiece dial recited in claim 1, wherein the substrate is made chiefly of polycarbonate and/or an acrylonitrile-butadiene-styrene copolymer.

12. The solar timepiece dial recited in claim 1, wherein the substrate is substantially white in color.

13. The solar timepiece dial recited in claim 1, wherein the light transmittance of visible light traveling from the substrate to the light polarizer is 20% or higher.

14. The solar timepiece dial recited in claim 1 wherein the substrate includes a base part and a coloring layer provided on the base part.

15. The solar timepiece dial recited in claim 14, wherein the coloring layer is made using a paint application method, a printing method, a wet plating method, or a dry plating method.

16. The solar timepiece dial recited in claim 1, wherein the substrate has the form of a curved plate.

17. A timepiece, having:
a drive unit;
a solar battery that is connected to the drive unit and configured to supply electric power to the drive unit; and
a solar timepiece dial comprising:
a plate-like substrate that is arranged closely adjacent to the solar battery and possesses a light transmissive quality;
a light polarizer that is provided between the substrate and the solar battery and functions to polarize incident light; and
a diffusion layer that is arranged between the substrate and the light polarizer and contains a diffusion agent functioning to diffuse incident light.

18. The timepiece recited in claim 17, wherein
the drive unit is configured to process time information.

19. The timepiece recited in claim 17, wherein
letters for indicating the time are provided on the solar timepiece dial; and
the drive unit is configured to indicate the time in cooperation with the letters.

20. The timepiece recited in claim 13, further provided with a case serving to house the drive unit, the solar battery, and the solar timepiece dial.

21. The timepiece recited in claim 15, further provided with a band that is connected to the case and configured to attach the timepiece to a user's body.
